(19) United States
(12) Patent Application Publication
(10) Pub. No.: US 2010/0130400 A1
(43) Pub. Date: May 27, 2010

(54) TOILET CLEANING BLOCK

(76) Inventors: Syed Husain Abbas, Casalpusterlengo (IT); Julie Rosalyn Das, Bebington (GB); Philip Michael Ryan, Wirral (GB); Ivan Valcarenghi, Lodi (IT); David Richard Ward, Bebington (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/595,691

(22) PCT Filed: Mar. 13, 2008
(86) PCT No.: PCT/EP08/53023

§ 371 Date: Jan. 15, 2010

(30) Foreign Application Priority Data
Apr. 16, 2007 (EP) 07106224.4

(51) Int. Cl. C11D 17/00

(52) U.S. Cl. 510/192

(57) ABSTRACT

The present invention relates to toilet cleaning blocks, and their use, in particular toilet cleaning blocks providing hygiene to a hard surface, wherein such a block is at least partially transparent or translucent appearance, in a solid, semi solid, or gel form. Accordingly the present invention provides a toilet cleaning block, which is at least partially transparent or translucent, and comprising a biocide and a carrier composition comprising soap, humectant and solvent.

### FIELD OF THE INVENTION

The present invention relates to hard surface cleaning blocks, and their use.

### BACKGROUND PRIOR ART

Hard surface cleaning blocks, such as lavatory blocks are known in the art and are typically configured to provide an automatic and sustained release of active ingredients to a liquid passing the block and/or the release of perfume to the air. For example, they may be suspended in a container under the rim of a lavatory bowl or urinal such that, during a flushing cycle, water from the cistern flows over the block thereby dissolving a portion of the block and releasing active ingredients of the block into the lavatory bowl. They may also be used inside a dish washing machine or even for the purpose of manual dishwashing.

Different types of hard surface cleaning blocks have been disclosed in the art.

For instance in EP 0 791 047, hard surface cleaning blocks are disclosed consisting of at least two aggregates of different composition, one of the aggregates being at least partially enclosed by the other aggregate(s), the enclosed aggregate containing an active ingredient in a concentration that is at least 1.3 times higher than the enclosing aggregate.

In EP 1 418 225, hard surface cleaning blocks, consisting of a detergent phase and a gel phase are disclosed.

In these and other hard surface cleaning blocks, the delivery of perfume to a room is the main objective.

U.S. Pat. No. 6,667,287 discloses a light duty liquid cleaning composition comprising a biocide (benzalkonium chloride) for providing hygiene to a toilet.

Hard surface cleaning blocks optionally comprising biocide are disclosed in the art. However, to be able to dose an effective amount of biocide to provide hygiene from a small hard surface cleaning block over a large number of flushes, requires a high level of biocide. A hard surface cleaning block comprising such a biocide compound in such effective amount to provide hygiene to a hard surface, in particular to a toilet bowl, remains to be desired.

It is an object of the present invention to provide a hard surface cleaning block providing hygiene to a hard surface.

It is a further object of the invention to provide such a block with an at least partially transparent or translucent appearance, in a solid, semi solid, or gel form.

It is a further object of the invention to provide a detergent block that rinses away in a number of flushes, and provides a hygiene agent at a uniform rate.

It is a further object of the invention not to compromise the possibilities to shape the detergent block in any appealing way.

We have surprisingly found that a hard surface cleaning block comprising biocide meets at least one of these objects.

### SUMMARY OF THE INVENTION

Accordingly, the invention provides toilet cleaning block, which is at least partially transparent or translucent, characterized in that it comprises:
a carrier composition comprising: soap, humectant and solvent; and
biocide material.

These and other aspects, features and advantages will become apparent to those of ordinary skill in the art from a reading of the following detailed description and the appended claims. For the avoidance of doubt, any feature of one aspect of the present invention may be utilised in any other aspect of the invention. It is noted that the examples given in the description below are intended to clarify the invention and are not intended to limit the invention to those examples per se. Similarly, all percentages are weight/weight percentages unless otherwise indicated. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

The hard surface cleaning block according to the invention comprises a carrier composition comprising melt cast soap, humectant and solvent; and biocide material. The composition is at least partially transparent or translucent, to meet consumer demands for an appealing product.

The hard surface cleaning block of the invention is intended to gradually release active ingredients, in particular biocide to the surface. This is achieved by providing a block that gradually erodes or dissolves when contacted or flushed with water.

One of the possible uses of the hard surface cleaning block according to the invention is its application in a toilet. Toilet blocks preferably last for at least 50 flushes, more preferably at least 200 flushes, but not more than 300 flushes

The hard surface cleaning block of the invention may be a solid, semi-solid or gel like composition in the meaning of Römpp Lexicon Chemie, 10^{th} edition, Stuttgart/New York, 1997.

### Carrier Composition

Three key components, being soaps, humectants and solvents are required in different proportions to obtain clear hard surface cleaning blocks. The carrier composition forms 50 to 98% by weight of the hard surface cleaning block of the invention. The carrier composition is preferably present in the block in a concentration of at least 75%, but preferably not more than 90%, more preferably not more than 80%.

Transparent or translucent carrier compositions are best formed by a physical blending of soap. Short chain soaps (e.g. C14 and smaller) are softer and better deformable, long chain (C18 and above) are hard and give more strength to the block. It has been found that the best performance is obtained when at least part of the soap is a C18 soap.

The level of soap with chain length from C8 to C18 in the block may range from 10 to 40%. Lower chain saturated soaps C8-C14 and higher chain unsaturated soaps form the soluble part of the soap. Higher chain saturated soap (C16-C20) are insoluble soaps and give the structure to the product. The ratio of the soluble soap to insoluble soap may range from 1:10 to 10:1. This ratio may be chosen based on the requirement of foaming properties, product hardness and dissolution behaviour of the product.

The soap is present in the carrier composition in a concentration of at least 5%, preferably at least 10%, more preferably at least 15%. The soap is present in carrier composition in a concentration of not more than 50%, preferably not more than 40%, more preferably not more than 30%.

Humectant maintains both structure and clarity, enabling salvation of the soap chains/ribbons to maintain microcrystalline domains. If these domains are kept small and prevent further crystal nucleation, then the resultant structure is transparent. Preferred humectants are polyhydroxylated organic compounds, such as sorbitol and sucrose.

Humectants help in minimizing the refractive index difference between liquid and solid phases of soap by increasing the refractive index of the liquid phase. The reduced refractive index difference of the two phases reduces the scattering of light which in turn helps in the transparency of the product.

The humectant is present in the carrier composition in a concentration of at least 30%, preferably at least 40%, more preferably at least 50%. The humectant is present in carrier composition in a concentration of not more than 90%, preferably not more than 75%.

Solvents also play an important role in the carrier composition. Preferred solvents include glycols, (e.g. monopropylene glycol/propane-1,2-diol), poly alkylene glycols (e.g. PEG, PPG), water and short chain organic solvents (e.g. ethanol or isopropanol) and perfumes.

The solvent is present in the carrier composition in a concentration of at least 5%, preferably at least 8%. The solvent is present in carrier composition in a concentration of not more than 30%, preferably not more than 25%.

### Biocide Material

Although soap itself is know to have some biocidal effect, that effect does not occur in a toilet cleaning. The biocidal effect of soap is mainly due to the high pH of soap. At the dilution rate of a toilet cleaning block (in the order of 0.2 g in each flush of ca 6 liters), the pH of the water in the sump of the toilet will be close to neutral.

Surprisingly, it has been found that even the use of high level of a biocide such as Benzalkonium chloride does not have negative impact on the transparency of the product.

Quaternary ammonium compounds are the most preferred. Examples of such compounds are amine oxides, CTAC (cetyl trimethyl ammonium chloride), and BAC (benzalkonium chloride). BAC is the most preferred.

The biocide is preferably present in a concentration of at least 2%, preferably at least 5%, more preferably at least 10%, most preferably at least 20%. The biocide is present in a concentration of up to 50%. Due to safety restrictions, some biocides may only be present in a concentration of no more than 25%.

### Optional Ingredients

The hard surface cleaning block according to the invention may further comprise detergent active, builders, dyes, perfume, hygiene agents, antioxidants, radical scavengers, chelating agents, hydrotropes, anticorrosion agents, opacifiers, brighteners, preservatives and/or abrasives.

However, further ingredient that compromise the transparent or translucent character of the block are not preferred.

Suitable detergent active are e.g. described in “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

### Adhesive Layer

The block according to the invention may optionally comprise an adhesive layer as disclosed in co-pending European patent application 6124234.3. The adhesive phase is preferably suitable for attaching the block according to the invention to a hard surface.

The adhesive phase comprises a hydrophobic adhesive material and optionally a hydrophilic adhesive material. The hydrophobic adhesive material is required for the invention to obtain suitable resistance to water. To obtain even stronger adhesion, the composition may further comprise a hydrophilic adhesive material.

The hydrophobic adhesive material comprises at least one of a hydrophobic compound with an aggregate melting point of 30 to 60° C., preferably 45 to 55° C. and a polymer. The hydrophobic compound is present in the hydrophobic adhesive material in a concentration of 25-60%, preferably 35-55%, more preferably 40-50% by weight based the hydrophobic adhesive material. The adhesive phase further comprises a polymer in a concentration of 5-75%, preferably 20-70%, more preferably 40-65%, most preferably 50-60% by weight based on the hydrophobic adhesive material.

The hydrophobic compound is preferably selected from natural or mineral oils, petrolatum, thickened oils, partially hydrogenated oils or fats, silicon oils and derivatives, thickened non polar solvent or low HLB non ionic surfactant and combinations thereof. Low HLB as defined herein means preferably less than 12, more preferably less than 10.

The polymer is preferably selected from natural and synthetic cellulosic polymers, such as carboxymethyl cellulose, polyacrylates, polyvinyl pyrolidone, maleic/vinyl copolymers, silicon based polymers and mixtures thereof.

The polymers in the hydrophobic adhesive material are preferably water insoluble and preferably swell in contact with water.

The adhesive phase optionally comprises a hydrophilic adhesive material. To prevent instant dissolution of the hydrophilic adhesive phase upon contact with water, the hydrophilic adhesive material, if present, is preferably positioned in such a way that it is connected to both the hard surface and the detergent phase or an intermediate phase between the detergent phase and the adhesive phase, while it is surrounded by the hydrophobic adhesive material on all other sides. Even though one would expect the hydrophilic adhesive material to be quickly dissolved by water, it is postulated, without wishing to be bound by a theory, that it is possible to obtain said further improved adhesion by the combination of hydrophobic adhesive material surrounding hydrophilic adhesive material, because the hydrophobic adhesive material stops the penetration of water while the hydrophilic adhesion material further improves the adhesive strength to the block.

The hydrophilic adhesive phase is preferably selected from starch based adhesive materials, hydrophilic polymers, fatty acid salts and/or mixtures thereof. One example of such a hydrophilic adhesive is a mixture comprising PVP polymer and sodium stearate.

The hydrophilic adhesive material is present in an amount of 0-60% by weight of the total adhesive phase. Preferably the ratio of hydrophobic:hydrophilic adhesive material is between 10:1 and 1:10, more preferably, between 5:1 and 1:5, still more preferably 4:1 and 1:2, most preferably between 2:1 and 1:1.

Either one or both of the adhesive materials may further comprise a suitable rheology modifier. Preferably, the rheology modifier is present in a concentration of 0-10%. Polymeric thickeners are an example of suitable rheology modifiers for fumed silica or silica oil; hydrogenated triglycerides or fatty acids are an example of suitable rheology modifiers for fatty acids and triglycerides; and an example of a suitable rheology modifier for anhydrous, hydrophobic oils is 12-Hydroxy stearic acid.

### Application

The block of the invention may be used for cleaning in any conventional way. The main areas for use of the blocks of the invention are all in the field of hard surface cleaning. The blocks may for instance be used for toilet cleaning (e.g. as a rim block or an in-cistern block) or machine dish washing (e.g. in a cage inside the dish washing machine).

In a preferred embodiment, a method for providing hygiene to a toilet is provided. In that method a hard surface cleaning block according to the invention is mounted in a toilet (e.g. by adhering it to the surface, or in a cage under the rim). The toilet is flushed, thereby wetting the block and dissolving a small portion (0.1-1.0% of the block, preferably 0.3-0.5%) in the flush water.

### Hardness of the Composition

The hard surface cleaning block of the invention may be a solid, semi-solid or gel like composition in the meaning of Römpp Lexicon Chemie, 10^{th} edition, Stuttgart/New York, 1997

The preferred hardness of the block is dependent on its purpose. In the context of this invention, the block hardness is measured by the method given below.

The block hardness may be analysed using a Penetrometer PNR10 (ex SUR Berlin). The method involves using a probe to mechanically penetrate the sample of interest using a known force. The penetrometer needle is positioned manually close to the surface of sample under test and impact measurement carried out. At RT (25 C) the result is displayed in ‘mm’ penetration depth into the sample and replicate readings carried out on a different part of the block. Low values correlate to hard samples, while higher values correspond to softer materials.

Suitable block can range from hard to very soft gels in a range of 1 to 19 mm penetration measured using the method above.

For gels to be squirted from a tube, a hardness of 12 to 19 mm penetration is preferred.

For a block to be use in a cage, for instance a cage holding a toilet rim block, a hardness of 1 to 11 mm penetration is preferred.

For a block that is adhered straight onto the toilet surface, e.g. by means of an adhesive layer attached to one side of the block, a somewhat flexible block, with a hardness of about 1 to 6 mm penetration, more preferably 4 to 9 mm is preferred.

### EXAMPLES

The invention is now illustrated by means of the following non limiting examples.

### Example 1

### Formulations Using Soap Base of 85 Tallow/15 Coco

| Ingredients | 1 | 2 | 3 | 4 |
|---|---|---|---|---|
| Soap base (85/15) | 35.0% | 37.0% | 30.0% | 30.0% |
| Propylene Glicol | 5.0% | — | — | 5.0% |
| Glycerin | 10.0% | 5.0% | — | 5.0% |
| Sorbitol | — | 10.0% | 10.0% | 5.0% |
| Sugar | 1.5% | — | 5.0% | — |
| Triethanol Amine | — | 1.5% | 1.5% | — |
| Benzalconium Chloride | 23.5% | 23.5% | 28.5% | 30.0% |
| Water | 15.0% | 15.0% | 13.0% | 15.0% |
| Perfume | 10.0% | 8.0% | 10.0% | 8.0% |
| No of flushes | >120 | >120 | >120 | >120 |

### Example 2

### Formulations Using Soap Base of 85 Tallow/15 Coco

| Ingredients | 5 | 6 | 7 |
|---|---|---|---|
| Transparent Soap Base | 71.5% | 67.5% | 56.0% |
| Sodium Stearate | — | 5.0% | — |
| Benzalconium Chloride | 23.5% | 23.5% | 40.0% |
| Perfume | 5.0% | 4.0% | 4.0% |
| No of flushes | >120 | >120 | >120 |

### Example 3

### Performance Lasting

The compositions of this example were tested for the number of flushes they lasted while maintaining the right product dosing to a toilet.

TABLE 2
Non Soap formulations using non ionic
surfactants.

| | | | | | |
|---|---|---|---|---|---|
| 5 | 6 | 7 | 8 | 9 | 10 |

| | | | | | | |
|---|---|---|---|---|---|---|
| Benzalconium | 23.5 | 23.5 | 23.5 | 20.0 | 23.5 | 30.0 |
| Chloride | | | | | | |
| C16-C18 | 56.5 | 59.5 | 52.5 | 42.0 | 45.5 | 47.0 |
| Fatty alcohol 25 EO | | | | | | |
| C9-C11 | 6 | 6 | 6 | 3.0 | 6 | 6 |
| Fatty alcohol 8EO | | | | | | |
| C20-C22 | 10 | 0 | 8 | 25.0 | 10 | 10 |
| Fatty alcohol 30 EO | | | | | | |
| Perfume | 4 | 4 | 8 | 10 | 8 | 5 |
| C20-22 fatty alcohol | 0 | 5 | 0 | 0 | 5 | 0 |
| PEG 6000 | 0 | 2 | 0 | 0 | 2 | 0 |
| Alkyl Poly Glucoside | 0 | 0 | 2 | 0 | 0 | 2 |
| Total | 100 | 100 | 100 | 100 | 100 | 100 |
| No. of Flushes | 300 | 160 | 160 | >150 | >150 | >150 |

As can be seen in these examples, the blocks in various compositions last for at least 150 flushes and up to 300 flushes.

### Example 3

### Hygiene Efficacy

The anti bacterial effect of the compositions according to the invention is demonstrated in this example.

A suitable method was devised for testing the efficacy of experimental toilet blocks under realistic conditions. This method uses a low level of bacteria and no additional soiling as the bulk of bacteria and soil are removed from the toilet during the flush and the purpose of the toilet block is to deliver a maintenance dose to control residual bacteria.

### Description of Method

The method below describes how to test for inherent performance from a fragment of block equivalent to the amount lost in a flush. This amount is calculated from block weight/flush lifetime and in this case is 30 g/300 flushes which equal 0.1 g per flush. A stock solution of the block to be tested is prepared in sterile water of standard hardness (as specified in EN1276) then a series of dilutions of this stock solution are prepared so as to give a set of final dilutions of ranging from 1 in 1000 to 1 in 50,000. At time zero each of these dilutions is mixed 1 to 1 with an inoculum of the test bacteria standardized to give a count of 2.0×10³ bacteria/ml-5.0×10³ bacteria/ml and left for a contact time of 1 and 4 hours, this gives a final “in-test” dilution range of 1 in 2000 to 1 in 100,000. A suitable bacteria for use in this test is E. coli (ATCC 10536). After the desired contact time a sample of each test solution is removed and diluted 1 in 10 in an appropriate neutralizer solution, such as universal neutralizer as described in EN1276, which has been supplemented with tryptone soy broth to allow outgrowth of surviving bacteria.

Effective block performance is measured as the highest dilution showing no growth, in 75% of test samples, of bacteria after 24 hours incubation at 37° C.

Example Toilet block formulations tested are given in the table below along with the dilutions achieving a pass after 1 and 4 hours contact time with E. coli.

| Ingredients (%) by weight | 11 | 12 |
|---|---|---|
| Prisavon 2013 soap (uniqema) | 0 | 58.5 |
| 85/15 short/long chain soap | 40 | 0 |
| Benzalkonium Chloride | 25 | 36.9 |
| C16-C18 FA Ethoxylate | 0 | 0 |
| Alfa Olefine Sulfonate | 0 | 4.6 |
| Lutensol AT25 | 0 | 0 |
| Propylene Glycol | 10 | 0 |
| Ethanol | 5 | 0 |
| Fragrance | 5 | 0 |
| Glycerine | 5 | 0 |
| Effective dilution (1 Hr) | 9,000 | 27,000 |
| Effective dilution (4 Hr) | 58,000 | Not tested |

Balance of formulations is water.

As can be seen from the results composition 12 already shows inhibition at a 1:27000 dilution after 1 hr. Composition 11 shows show inhibition at a dilution of more than 1:50000 and 4 hours contact time.

1. A toilet cleaning block, which is at least partially transparent or translucent, characterized in that it comprises:
a. 50 to 98% by weigh of the block of a carrier composition comprising:
i. 5 to 50% by weight of the carrier composition soap
ii. 30 to 90% by weight of the carrier composition humectant; and
iii. 5 to 30% by weight of the carrier composition is solvent.
b. 2 to 50% by weight of the block of biocide material

2. A toilet cleaning block according to claim 1, wherein the composition further comprises an adhesive layer, wherein the adhesive layer comprises a hydrophobic adhesive material comprising:
a. 25-60% of at least one hydrophobic compound, having an aggregate melting point of 30-60° C.; and
b. 5-75% of a polymer.

3. A block according to any one of claims 1 or 2, wherein the Biocide material is selected from Quaternary ammonium based biocides.

4. A block according to any one of claims 1 to 3, wherein the block further comprises an adhesive layer.

5. A block according to any one of claims 1 to 4, wherein the block hardness is 1 to 19 mm.

6. Method for providing hygiene in a toilet comprising the steps of:
a. Applying the block according to claims 1-5 to the toilet surface.
b. Flushing the toilet with water

7. Use of the block of any one of claims 1-5, for providing hygiene in a toilet.
